(19) United States
(12) Patent Application Publication
(10) Pub. No.: US 2008/0179975 A1
(43) Pub. Date: Jul. 31, 2008

(54) RESOLVER AND MOTOR

(75) Inventors: Nakaba KATAOKA, Kyoto (JP); Keita NAKANISHI, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 12/020,705

(22) Filed: Jan. 28, 2008

(30) Foreign Application Priority Data
Jan. 29, 2007 (JP) 2007-017386

(51) Int. Cl. H02K 24/00

(52) U.S. Cl. 310/71

(57) ABSTRACT

An insulator is arranged to cover a resolver stator core and includes a cover portion arranged to cover a core back portion and a tooth cover portion for covering a corresponding tooth. In the cover portion, a bridge pin is disposed to project axially upward. After a conductive wire is wound around a tooth, and hooked on the bridge pin, the conductive wire is wound around another tooth. In the case where the insulator is formed by injection molding, an injection gate scar portion is formed on a top surface of the bridge pin, at a position radially outside a crossover portion of the conductive wire, on a top surface of an inner wall of the tooth cover portion, or on a back surface of the insulator.

### BACKGROUND OF THE INVENTION

1. Field of the Invention

The present invention relates to a resolver and a motor on which the resolver is mounted.

2. Description of the Related Art

A resolver is a type of rotational position sensing mechanism for sensing a rotational position of a rotating body of a brushless motor. A resolver is defined by a resolver stator having a plurality of teeth, and a resolver rotor which is rotatable with respect to the resolver stator.

A conductive wire (an excitation winding or an output winding) is wound around each tooth of the resolver stator. The resolver detects variations in voltage output from the output winding in accordance with changes of a radial gap between the resolver stator and the resolver rotor. Based on the variations in voltage, the rotational position of the rotating body is detected.

The resolver stator is defined by a resolver stator core which is a magnetic body of metal, and an insulator with electrical insulation for covering the resolver stator core. The insulator is made of a resin and is formed by injection molding.

In the case where the insulator is manufactured by injection molding, it is necessary for any region of the insulator to correspond with the position of a gate which is an injecting position of the resin into the inside of the injection molding die (a cavity). Specifically, the injecting position of the resin into the inside of the die (the cavity) is set to be any region of the insulator. In a position corresponding to the position of the gate, burrs are caused when the molded product is removed from the gate during the release of the mold.

On the other hand, the conductive wire used for the resolver is a metal wire having a very small diameter (for example, the diameter of the conductive wire is about 0.09 mm). Accordingly, if the conductive wire accidentally comes into contact with the burrs of the insulator, the conductive wire is damaged. In addition, there is a possibility that breakage of the conductive wire may occur by the contact with the burrs. As a resolution to this problem, a method for removing the burrs from the surface of the insulator is considered. This method requires an additional new step, and the number of steps for manufacturing the resolver is disadvantageously increased.

### SUMMARY OF THE INVENTION

In order to overcome the problems described above, preferred embodiments of the present invention provide a resolver including a resolver rotor which rotates about a center axis, a resolver stator having a resolver stator core radially opposite to the resolver rotor with a predetermined gap therebetween, an insulator made of an electrically insulating material and arranged to cover an outer surface of the resolver stator core, and coils defined by winding conductive wires on the resolver stator core.

The resolver stator core may include a plurality of teeth, i.e., magnetic pole portions which extend radially and are circumferentially spaced, and a core back portion provided integrally with the plurality of teeth. The conductive wire is successively wound around two or more of the teeth.

In the insulator of the resolver, a plurality of pins may be provided for defining a path of the conductive wire between the plurality of teeth which are integral with the insulator. The pins extend in an axial direction parallel or substantially parallel to the center axis. On a top surface of at least one of the pins, an injection gate scar portion is disposed, i.e., a gate portion at which a resin, or any other suitable insulating material, forming the insulator is injected when the insulator is formed.

The insulator may include a cover portion covering an end surface of the core back portion. The injection scar portion may be disposed on a surface of the cover portion opposite to the core back portion.

In the insulator, the injection scar portion may be disposed in a position other than a position in which a crossover portion of the conductive wire bridging the tooth portions is disposed.

The insulator may have a tooth cover portion covering a corresponding one of the teeth. In the tooth cover portion, a wall portion for preventing the winding failure of the conductive wire is disposed. The injection scar portion may be disposed on a top surface of the wall portion.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a schematic sectional view showing a brushless motor according to a preferred embodiment of the present invention taken along its axial direction.

FIG. 2 is a schematic plan view of a resolver according to a preferred embodiment of the present invention.

FIG. 3 is a schematic sectional view of a resolver stator according to a preferred embodiment of the present invention taken along the axial direction.

FIG. 4 is a perspective view showing a surface of an upper insulator according to a preferred embodiment of the present invention.

FIG. 5 is a perspective view showing a back surface of the upper insulator.

FIG. 6 is a perspective view showing a lower insulator according to a preferred embodiment of the present invention.

FIG. 7 is a schematic view showing an example of an arrangement of an injecting position of a molding material.

FIG. 8 is a schematic view showing another example of an arrangement of the injecting position of the molding material.

FIG. 9 is a schematic view showing still another example of the injecting position of the molding material.

FIG. 10 is a schematic sectional view of a terminal pin disposed in the upper insulator taken along the axial direction.

### DETAILED DESCRIPTION OF PREFERRED EMBODIMENTS

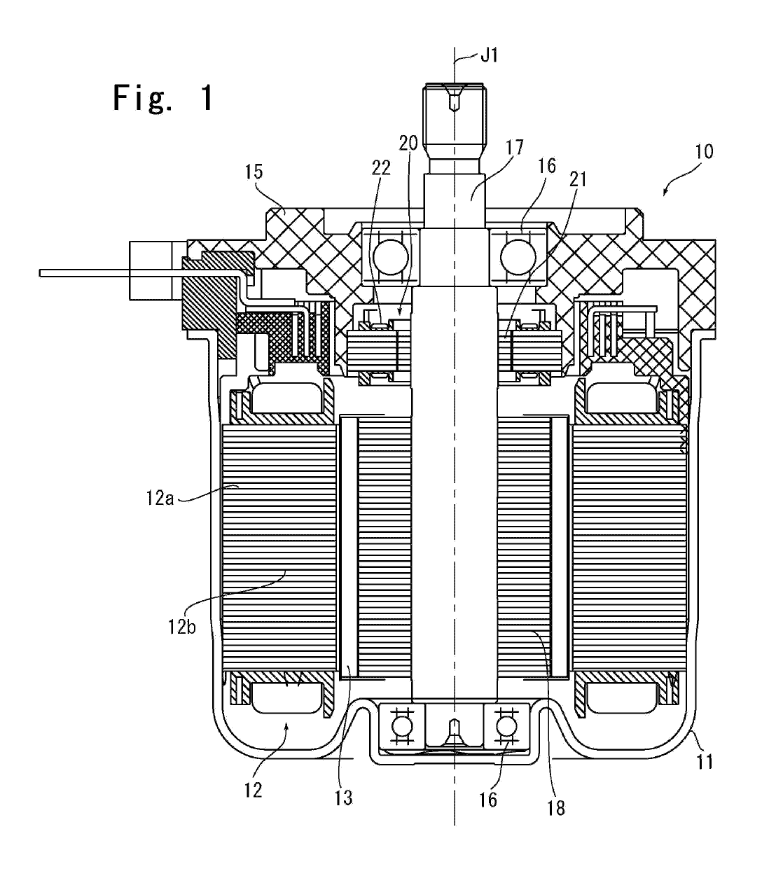

Referring to FIGS. 1 through 10, preferred embodiments of the present invention will be described in detail. It should be noted that in the explanation of the preferred embodiments of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to or substantially parallel to a center axis of a motor, and a radial direction indicates a direction perpendicular to or substantially perpendicular to the center axis.

### Structure of the Motor

The structure of a motor according to a preferred embodiment of the present invention is now described with reference to FIG. 1. FIG. 1 is a schematic sectional view of a brushless motor according to a preferred embodiment of the present invention taken along its axial direction parallel or substantially parallel to its center axis.

In the present preferred embodiment, the motor preferably is a brushless motor driven by a three-phase current supplied from a power source, which is not shown. A resolver of the motor includes a resolver rotor and a resolver stator which will be described later. The resolver is a position sensing mechanism arranged to sense a voltage, as a position sensing signal, of a coil of the resolver stator generated in accordance with the variation of a radial gap between the resolver rotor and the resolver stator due to the rotation of the resolver rotor.

With reference to FIG. 1, a brushless motor 10 includes a housing 11 having a hollow portion and a bottom portion for covering a lower portion of the hollow portion. In this preferred embodiment, the hollow portion is approximately cylindrical about a center axis J1. In the housing 11, a stator 12 and a rotor magnet 13 are accommodated therein. An upper portion of the housing 11 is open. To the upper portion of the housing 11, a bracket 15 having an opening at its center is attached. A ball bearing 16 and a resolver 20 are retained in the center opening of the bracket 15. Another ball bearing 16 is retained in the bottom portion of the housing 11. A shaft 17 is rotatably supported with respect to the stator 12 by the ball bearings 16.

The stator 12 is fixed to an inner surface of the housing 11. The stator 12 includes a core back portion 12a having an approximately annular configuration with the center axis J1 as its center, and a plurality of teeth 12b extending from the core back portion 12a to the center axis J1. The teeth 12b are disposed such that they are mutually spaced in a circumferential direction.

A yoke 18, which is formed by laminating a plurality of magnetic steel plates, for example, is fixed to the shaft 17. The rotor magnet 13 is fixed to a side surface of the yoke 18. The yoke 18 and the rotor magnet 13 rotate about the center axis J1 integrally with the shaft 17. The shaft 17, the yoke 18, and the rotor magnet 13 define a rotating body.

A resolver rotor 21 of the resolver 20 as the position sensing mechanism is fixed to the shaft 17 axially above the yoke 18. The resolver rotor 21 is disposed on a radially inner side of the opening of the bracket 15. As for the resolver rotor 21, the outer rim thereof is preferably not a perfect circular shape as seen in a plan view from above. A resolver stator 22 is disposed via a predetermined radial gap from the resolver rotor 21. The resolver stator 22 is fixed to an inner side surface of the bracket 15 which defines the opening.

As for the brushless motor 10, the rotational position of the rotating body is sensed by the resolver 20. Based on the sensed rotational position of the rotating body, a control device which is not shown supplies a current to coils formed by winding conductive wires around the teeth 12b of the stator 12. Accordingly, a rotation torque about the center axis J1 is generated by interaction between the stator and the rotor magnet 13. In this way, the brushless motor 10 is driven.

### Structure of the Resolver

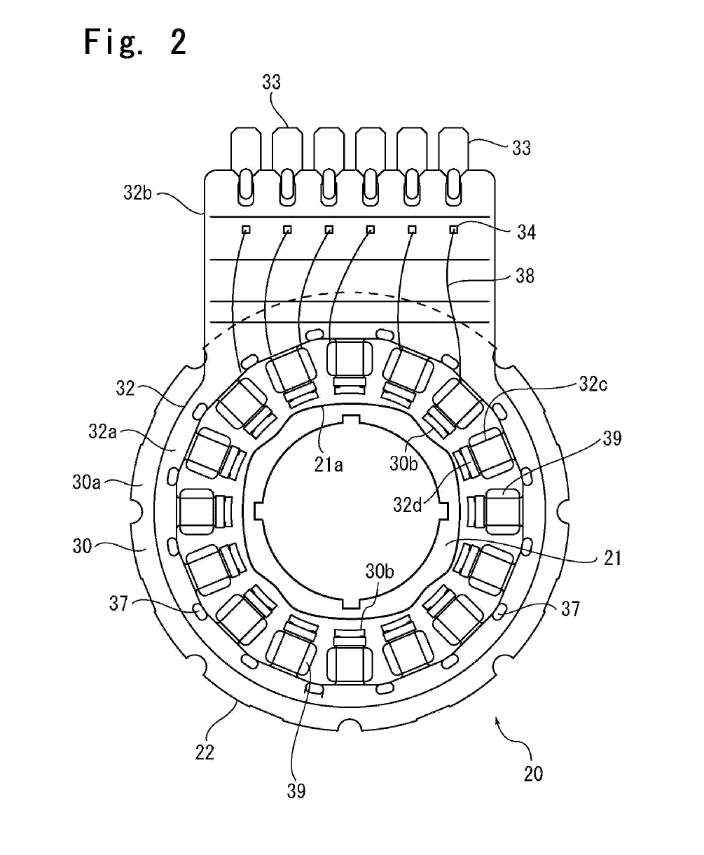

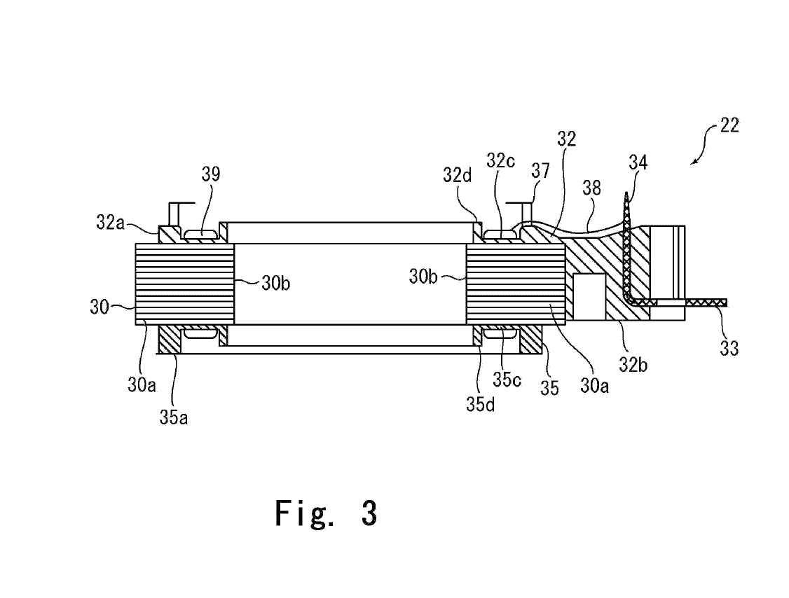

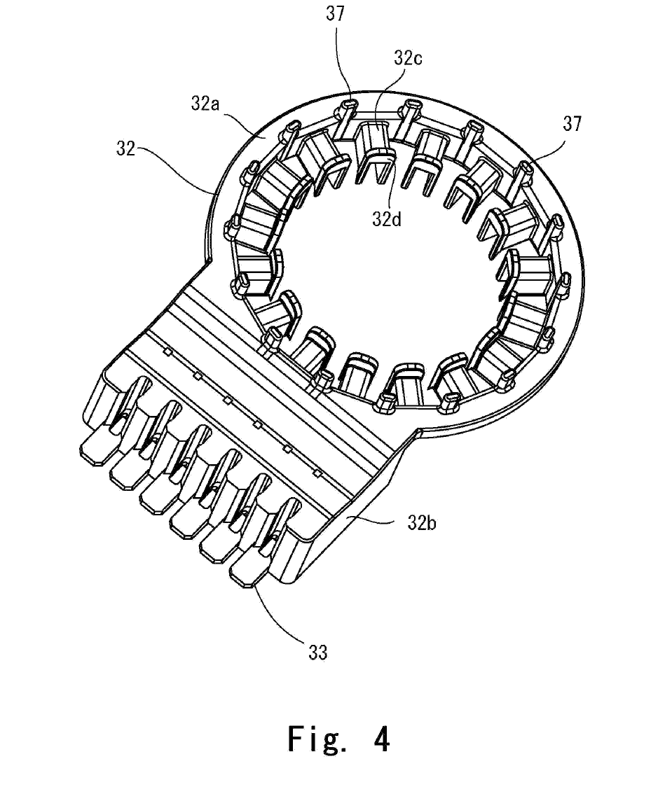

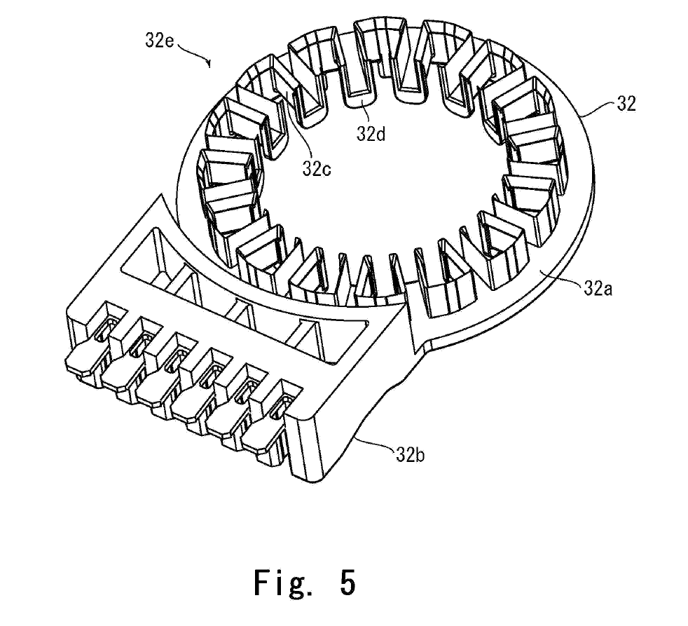

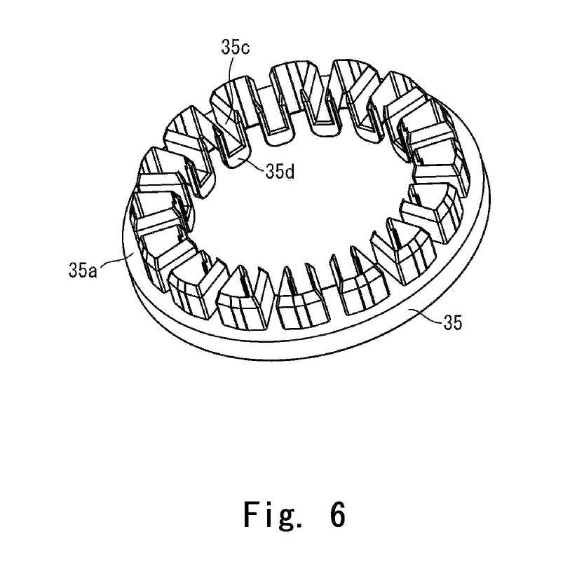

A structure of the resolver 20 in the present preferred embodiment is now described with reference to FIGS. 2 to 6. FIG. 2 is a schematic plan view of an exemplary resolver. FIG. 3 is a schematic sectional view of an exemplary resolver stator taken along the axial direction. FIG. 4 is a perspective view showing a surface of an upper insulator of the resolver. FIG. 5 is a perspective view showing a back surface 32e of the upper insulator of the resolver. FIG. 6 is a perspective view showing a lower insulator of the resolver.

In the following description, the up-and-down orientation of FIG. 1 is conveniently used as the up-and-down orientations of the brushless motor 10 and the resolver 20 mounted on the brushless motor 10.

With reference to FIGS. 2 and 3, a resolver stator 22 includes a resolver stator core 30 and insulators 32 and 35 preferably made of a resin, or other suitable insulating material, which axially surround the resolver stator core 30 on both sides.

The resolver stator core 30 includes a core back portion 30a arranged approximately annularly about the center axis J1, and a plurality of teeth 30b radially extending from the core back portion 30a toward the center axis J1. The teeth 30b are mutually spaced in a circumferential direction of the core back portion 30a. Each tooth 30b has a surface which is radially opposite to a side surface of the resolver rotor 21. As for the shape of the side surface (the shape of the outer circumference) of the resolver rotor 21, as shown in FIG. 2, protruding portions 21a are arranged in four positions on the circumference thereof. When the resolver rotor 21 rotates integrally with the shaft 17, the size of the radial gap between the resolver rotor 21 and a certain tooth 30b varies.

Referring to FIG. 4, the insulator 32 includes a cover portion 32a disposed on an upper side of the core back portion 30a, a connector portion 32b extending radially outwards from a circumferential portion of the cover portion 32a, and a plurality of tooth cover portions 32c protruding radially inwards from the cover portion 32a. The tooth cover portion 32c is disposed so as to cover a corresponding one of the teeth 30b from above. An inner wall 32d is provided at an end of the tooth cover portion 32c. The inner wall 32d protrudes upward from an upper surface of the tooth cover portion 32c.

Referring to FIG. 6, the insulator 35 includes a cover portion 35a, and a plurality of tooth cover portions 35c protruding radially inwards from the cover portion 35a. In this preferred embodiment, the cover portion 35a has a substantially annular shape, for example, and is disposed in a position opposite to the cover portion 32a with respect to the core back portion 30a. The tooth cover portion 35c covers a corresponding one of the teeth 30b from the bottom. An inner wall 35d is provided at an end of the tooth cover portion 35c. The inner wall 35d protrudes from a lower surface of the tooth cover portion 35c.

Referring to FIGS. 2, 3, and 4, at an end of the connector portion 32b opposite to the cover portion 32a, a plurality of conductive terminal members 33 are embedded. In this preferred embodiment, the terminal member 33 is a bent member having approximately an L shape in cross-section, as shown in FIG. 3. The terminal member 33 is preferably made of metal, for example. One end of the terminal member 33 projects radially outwards from the connector portion 32b. A lead wire (not shown) is connected to the one end of the terminal member 33. The lead wire is connected to a control device (not shown). As shown in FIGS. 2 and 3, the other end of the terminal member 33 projects axially upward from an upper surface of the connector portion 32b. In the following description, the other end of the terminal member 33 projecting axially upward from the upper surface of the connector portion 32b is referred to as a terminal pin 34.

In this preferred embodiment, six terminal pins 34 are arranged linearly, as shown in FIG. 2. In other words, six terminal members 33 are embedded in the connector portion 32b.

A plurality of bridge pins 37 are disposed on the upper surface of the cover portion 32a at regular intervals in the circumferential direction of the cover portion 32a to protrude from the cover portion 32a. The bridge pins 37 are provided over an entire circumference of the cover portion 32a which is approximately annular in shape.

As shown in FIG. 2, the resolver stator 22 has coils 39 formed by winding conductive wires 38 around predetermined teeth 30b. One end of a conductive wire 38 is joined to a predetermined terminal pin 34, and then the conductive wire 38 is wound successively around a plurality of predetermined teeth 30b, thereby forming coils 39. Finally, the conductive wire 38 is joined to a terminal pin 34 which is different from the predetermined terminal pin 34. A portion of the conductive wire 38 between the terminal pin 34 and the tooth 30b sags. The conductive wire 38 is wound around the plurality of teeth 30b in the following manner. First, the conductive wire 38 is wound around one tooth 30b so as to form a coil 39, and then hooked on the bridge pin 37. Thereafter, the conductive wire 38 is wound around another tooth 30b, so as to form another coil 39. In FIG. 2, the conductive wire 38 drawn between respective tooth portions 30b is omitted.

In this preferred embodiment, six terminal pins 34 are arranged, and three conductive wires 38 are used, because one conductive wire 38 starts from one predetermined terminal pin 34 and returns to another predetermined terminal pin 34. Each of the conductive wires 38 is wound around a plurality of teeth 30b, thereby forming a plurality of coils 39.

One of the three conductive wires 38 defines an excitation winding for supplying a current to the coils. The other two wires define output windings for outputting a voltage to the control device (not shown) caused in the coils due to the rotation of the resolver rotor 21. Such a resolver 20 is a resolver of variable reluctance type. The resolver 20 senses the rotational position of the resolver rotor 21, i.e., the rotational position of the rotating body based on an output signal from the output windings obtained by utilizing variations in size of the radial gap between the resolver rotor 21 and the tooth portions 30b in association with the rotation of the resolver rotor 21.

### Injection Scar Portion (Gate Portion)

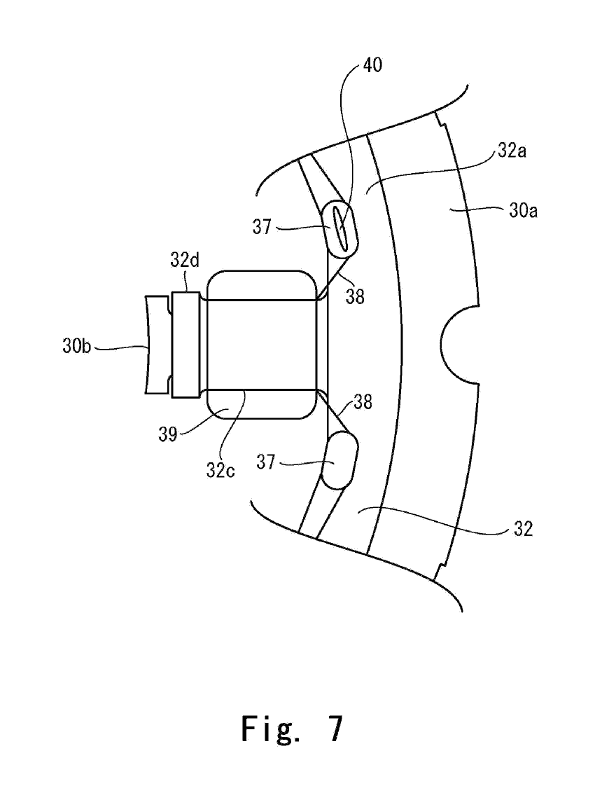

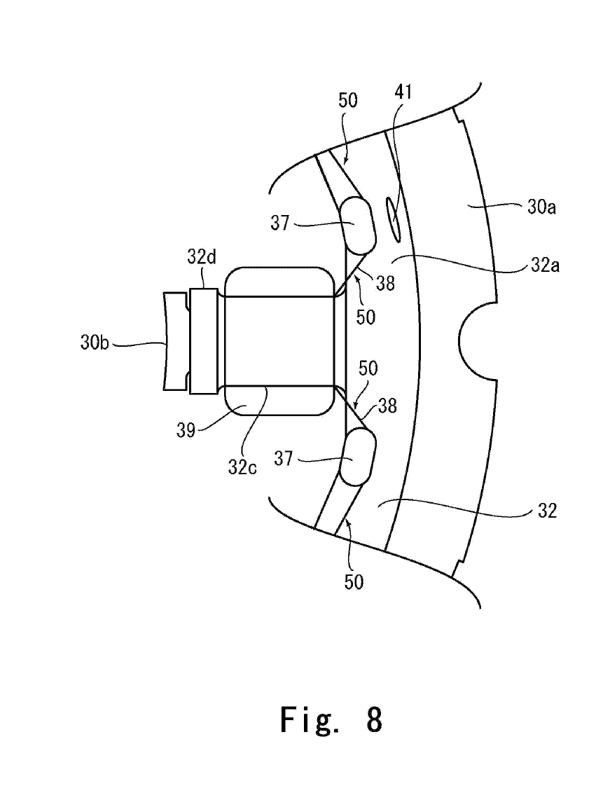

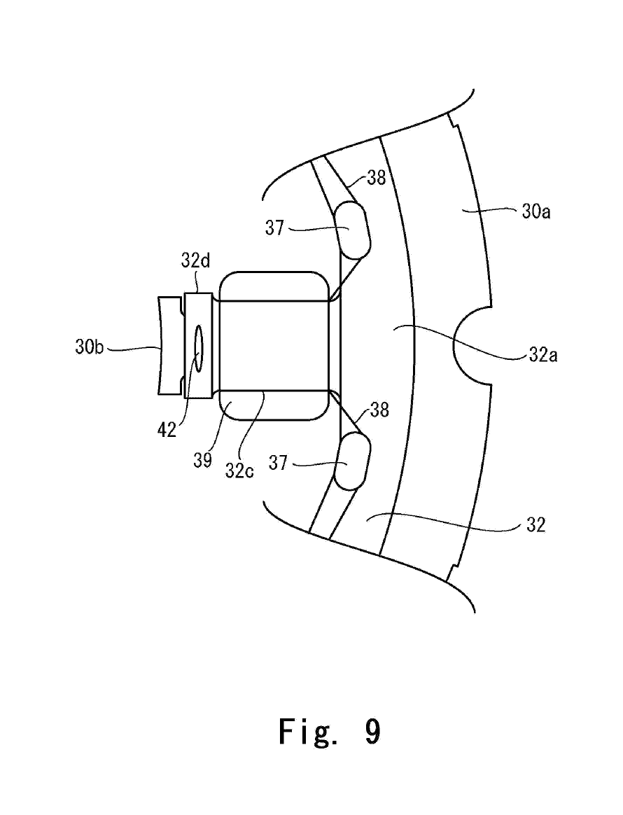

Next, the manufacture of the insulator 32 is described with respect to FIGS. 7 to 9. FIG. 7 is a schematic view showing an example of an arrangement of an injecting position of a molding material according to a preferred embodiment of the present invention. FIG. 8 is a schematic view showing another example of the arrangement of the injecting position of the molding material. FIG. 9 is a schematic view showing still another example of the arrangement of the injecting position of the molding material.

The insulators 32 and 35 are produced by injection molding in which a resin material is injected into a mold.

### FIRST EXAMPLE

With reference to FIG. 7, a conductive wire 38 is wound around a tooth 30b (precisely, the conductive wire 38 is wound around the tooth cover portions 32c and 35c), and hooked on a bridge pin 37. Thereafter, the conductive wire 38 is guided to another tooth 30b. Alternatively, after the conductive wire 38 is hooked on the bridge pin 37, the conductive wire 38 is guided to a terminal pin 34.

In the first example, a gate position as the injecting port through which a resin material is injected into a cavity of a mold which is not shown in the injection molding of the insulator 32 is made to correspond to a top surface of the bridge pin 37. That is, on the top surface of the bridge pin 37, an injection scar portion 40 is formed as the separation scar of the gate position. In the injection scar portion 40, burrs may be formed during the release of the mold in the injection molding. Accordingly, as shown in FIG. 7, since the injection scar portion 40 is provided on the top surface of the bridge pin 37, the contact of the injection scar portion 40 with the conductive wire 38 can be prevented. In other words, the conductive wire 38 is in contact with the side surface of the bridge pin 37, so that the conductive wire 38 is not in contact with the top surface of the bridge pin 37. Accordingly, it is possible to prevent the conductive wire 38 from being damaged or broken by contact with the injection scar portion 40.

In this first example, the injection scar portion 40 is located at a position radially separated from the end of the tooth 30b. Moreover, the injection scar portion 40 is located above the insulator 32. Accordingly, an accidental situation where the burrs formed in the injection scar portion 40 are peeled off and caught between an inner surface of the resolver stator 21 and a side surface (an outer circumference) of the resolver rotor 22 can be largely reduced.

In FIG. 7, only one bridge pin 37 corresponding to the gate position is shown. However, when a plurality of gate positions are to be provided, a plurality of gate positions are formed in a corresponding manner on the top surfaces of a plurality of bridge pins 37. Specifically, on each of the plurality of bridge pins 37, an injection scar portion 40 is formed. If a plurality of gate positions are prepared, the moldability of the insulator 32 can be improved.

### SECOND EXAMPLE

Next, with reference to FIG. 8, the conductive wire 38 is wound around a tooth 30b, and hooked on a bridge pin 37. Thereafter, the conductive wire 38 is guided to another tooth 30b. As shown in FIG. 8, a portion of the conductive wire 38 drawn between the bridge pin 37 and the tooth 30b is referred to as a crossover portion 50. That is, after the conductive wire 38 is wound around the tooth 30b, a crossover portion 50 extends therefrom. Then, after the conductive wire 38 is hooked on the bridge pin 37, the crossover portion 50 is further extended. Thereafter, the conductive wire 38 is wound around another tooth portion 30b.

In the second example, in the injection molding of the insulator 32, the gate position is disposed outside the crossover portion 50 in the radial direction of the resolver 20. That is, the injection scar portion 41 is disposed radially outside the crossover portion 50. Accordingly, it is possible to prevent the conductive wire 38 (i.e., the crossover portion 50) from contacting the injection scar portion 41. Therefore, even if burrs are created by the injection scar portion 41, the conductive wire 38 is not in contact with the burrs, so that it is possible to prevent the conductive wire 38 from being damaged or broken.

The injection scar portion 41 is located at a position radially separated from the end position of the tooth 30b. Moreover, the injection scar portion 41 is located above the insulator 32. Accordingly, an accidental situation where the burrs formed in the injection scar portion 41 are peeled off and caught between an inner surface of the resolver stator 21 and a side surface (an outer circumference) of the resolver rotor 22 can be largely reduced.

### THIRD EXAMPLE

Next, with reference to FIG. 9, in the third example, in the injection molding of the insulator 32, the gate position corresponds to a top surface of an inner wall 32d of the insulator 32. That is, an injection scar portion 42 is formed on the top surface of the inner wall 32d. Since the inner wall 32d is disposed radially inside a coil 39, the conductive wire 38 is in contact only with a radially outer side surface of the inner wall 32d. Therefore, the conductive wire 38 is not in contact with the injection scar portion 42. As a result, even if burrs are formed in the injection scar portion 42, the conductive wire 38 is not in contact with the burrs, so that it is possible to prevent the conductive wire 38 from being damaged or broken.

Since the injection scar portion 42 is formed on the top surface of the inner wall 32d, an accidental situation where the burrs formed in the injection scar portion 42 are peeled off and caught between an inner surface of the resolver stator 21 and a side surface (an outer circumference) of the resolver rotor 22 can be largely reduced.

### FOURTH EXAMPLE

Next, in the fourth example, in the injection molding of the insulator 32, the gate position corresponds to a back surface 32e of the insulator 32. Specifically, as shown in FIG. 5, an injection scar portion is formed in any position of the back surface 32e of the insulator 32. Accordingly, even if burrs are formed in the injection scar portion due to the injection molding, the conductive wire 38 is not disposed on the side of the back surface 32e, so that it is possible to prevent the conductive wire 38 from being in contact with the burrs. Accordingly, it is possible to prevent the conductive wire 38 from being damaged or broken by the contact of the burrs with the conductive wire 38.

Since the injection scar portion is formed on the back surface 32e of the insulator 32, an accidental situation where the burrs formed in the injection scar portion are peeled off and caught between an inner surface of the resolver stator 21 and a side surface (an outer circumference) of the resolver rotor 22 can be largely reduced.

In the case where the injection scar portion is formed on the back surface 32e of the insulator 32, the injection scar portion is desirably formed in a portion corresponding to the cover portion 32a. The tooth cover portion 32c is required to be thin in order for the conductive wire 38 to be wound many times. However, the cover portion 32a is not required to be thin. Since a certain degree of thickness is required for forming an injection scar portion, it is desired that the injection scar portion be formed in a portion corresponding to the cover portion 32a.

### Shape of the Terminal Pin

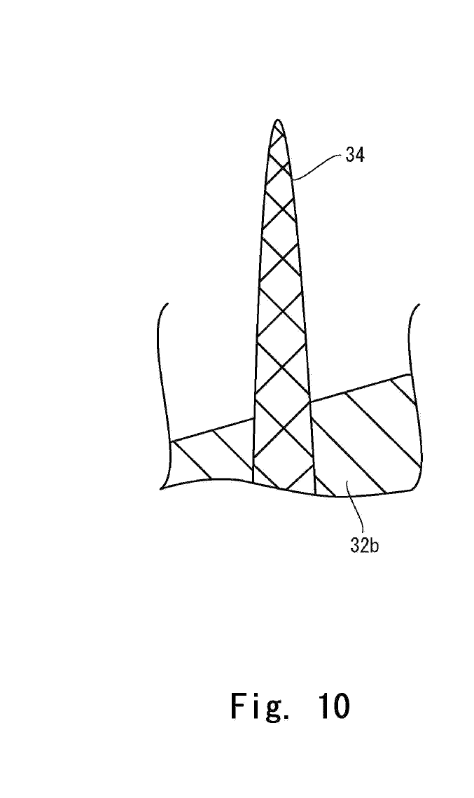

Next, the shape of the terminal pin 34 is described with reference to FIG. 10. FIG. 10 is a schematic sectional view of the terminal pin 34 disposed in an upper insulator, i.e., the insulator 32, taken along the axial direction.

With reference to FIG. 10, the terminal pin 34 is formed such that a cross-sectional area of an upper portion thereof (an area of a cross section taken along a plane perpendicular to a direction in which the terminal pin 34 extends) is gradually reduced toward the axially upper end.

The terminal pin 34 and the conductive wire 38 are joined by welding, for example. In this case, after the conductive wire 38 is wound around the upper portion of the terminal pin 34, they are joined by applying heat. In this preferred embodiment, the cross-sectional area of the upper portion of the terminal pin 34 is small, so that the required time for applying heat can be shortened. Alternatively, the heating temperature can be set to be low. Accordingly, in the joining process by welding for the terminal pin 34 and the conductive wire 38, it is possible to prevent the conductive wire 38 having a small diameter of wire from being broken by due to excessive heat.

The motor 10 on which the respective resolver 20 described in any of the above-described examples is mounted is, for example, desirably mounted on a power steering device for assisting the operation of a handle in a vehicle. That is, it is necessary for the power steering apparatus to ensure high positional control and high reliability for the use in vehicles. In the resolver 20 of any of the above-described examples, it is possible that the conductive wire 38 is prevented from being damaged or broken, so that high reliability can be attained for the resolver.

Preferred embodiments of the present invention are described above. However, the present invention is not limited to the above-described preferred embodiments, but can be variably modified.

For example, in the second and third examples of the arrangement of the injection scar portions, the injection scar portions 41 and 42 are preferably formed on the radially outer side of the crossover portion 50 and on the top surface of the inner wall 32d, respectively. However, the present invention is not limited thereto. The injection scar portions 41 and 42 may be formed in other positions. That is, the injection scar portion may be formed in a position on the upper surface of the insulator 32 other than the position where the conductive wire 38 is disposed. More specifically, the injection scar portions 41 and 42 may be disposed in positions other than the tooth cover portion 32c around which the conductive wire 38 is wound, and other than the crossover portion 50 extending from the conductive wire 38.

Moreover, for example, in the first example of the injection scar portion, the injection scar portion 40 is preferably disposed in one or a plurality of bridge pins 37 of the bridge pins 37. The present invention is not limited thereto. The injection scar portion 40 may be formed in each of the bridge pins 37. In the third example of the injection scar portion, the injection scar portion 42 is disposed on the top surface of the inner wall 32d, but the number of the injection scar portions 42 is not limited. However, in the case where the injection scar portions 42 are formed on the top surfaces of all of the inner walls 32d, it is possible to improve the moldability of the insulator 32.

Furthermore, for example, the core back portion 30a of the resolver stator core 30 of the above-described preferred embodiments preferably has an approximately annular shape with the center axis J1 as its center. However, the present invention is not limited thereto. Alternatively, the core back portion of the resolver stator core may have an arcuate shape. Alternatively, the core back portion has an annular shape, which is not limited to a circularly annular shape. The core back portion may have a polygonal annular shape. The shape of the cover portion 32a of the insulator 32 may be changed in accordance with the change of the shape of the core back portion. Accordingly, if the core back portion has an arcuate shape, the cover portion of the insulator also has an arcuate shape.

Moreover, for example, in the tooth cover portion 32c of the preferred embodiments of the present invention, only the inner wall 32d is provided. However, the present invention is not limited to this. For example, an outer wall may be provided on the radially outer side from the coil 39 of the tooth cover portion for preventing the winding deformation of the conductive wire 38 of the coil 39. Herein, a wall portion includes the inner wall 32d and the outer wall.

Although the resolver having a plurality of conductive wires is described in the above description, the resolver may include a single conductive wire.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A resolver for sensing a circumferential position of a rotating body with respect to a center axis, comprising:
a resolver rotor arranged to rotate about the center axis;
a resolver stator having a resolver stator core radially opposite to the resolver rotor with a predetermined gap interposed therebetween;
an insulator made of an electrically insulating material and covering an outer surface of the resolver stator core; and
a plurality of coils having a conductive wire wound around the resolver stator core; wherein
the resolver stator core has a plurality of radially extending teeth which are circumferentially spaced;
the conductive wire is wound successively around at least two of the plurality of teeth;
a plurality of pins define a path of the conductive wire between the plurality of teeth, and the plurality of pins are integral with the insulator;
the plurality of pins extend axially; and
an injection gate scar is disposed on a top surface of at least one of the pins.

2. A resolver according to claim 1, wherein
the resolver stator core has a substantially annular core back portion integral with the teeth;
the insulator has a substantially annular cover portion covering at least a portion of an axial end surface of the core back portion;
the pins are integral with the cover portion and are disposed annularly; and
the injection gate scar is disposed on at least two of the plurality of pins.

3. A resolver according to claim 2, wherein the injection gate scar is disposed on each of the plurality of pins.

4. A motor comprising:
the resolver according to claim 1;
the rotating body including a shaft disposed coaxially with the center axis, and a rotor magnet rotating integrally with the shaft; and
a fixed body including a stator radially opposite to the rotor magnet; wherein
the resolver rotor is attached to the shaft; and
the resolver stator is attached to the fixed body.

5. A resolver for sensing a circumferential position of a rotating body with respect to a center axis, comprising:
a resolver rotor arranged to rotate about the center axis;
a resolver stator having a resolver stator core radially opposite to the resolver rotor with a predetermined gap interposed therebetween;
an insulator made of an electrically insulating material and covering an outer surface of the resolver stator core; and
a plurality of coils having a conductive wire wound around the resolver stator core; wherein
an injection gate scar is disposed on one surface of the insulator opposite to an axial end surface of the resolver stator core.

6. A resolver according to claim 5, wherein
the resolver stator core has a plurality of teeth extending toward the resolver rotor, and a substantially annular core back portion integral with the teeth;
the insulator has a cover portion covering at least a portion of the axial end surface of the core back portion; and
the injection gate scar is disposed on the cover portion.

7. A resolver according to claim 5, wherein the insulator is defined by two members covering the resolver stator core on both sides in an axial direction parallel to or substantially parallel to the center axis.

8. A motor comprising:
the resolver according to claim 5;
the rotating body including a shaft disposed coaxially with the center axis, and a rotor magnet rotating integrally with the shaft; and
a fixed body including a stator radially opposite to the rotor magnet; wherein
the resolver rotor is attached to the shaft; and
the resolver stator is attached to the fixed body.

9. A resolver for sensing a circumferential position of a rotating body with respect to a center axis, comprising:
a resolver rotor arranged to rotate about the center axis;
a resolver stator having a resolver stator core radially opposite to the resolver rotor with a predetermined gap interposed therebetween;
an insulator made of an electrically insulating material and covering an outer surface of the resolver stator core; and
a plurality of coils having a conductive wire wound around the resolver stator core; wherein
the resolver stator core has a plurality of teeth extending toward the resolver rotor, and a core back portion integral with the plurality of teeth;
the insulator has a cover portion covering a portion of an axial end surface of the core back portion;
the conductive wire is wound successively around two or more of the teeth, the conductive wire having a crossover portion extending between two of the teeth; and
an injection gate scar is disposed in a position of the cover portion other than a position where the crossover portion extends.

10. A resolver according to claim 9, wherein the injection gate scar is disposed radially outside the crossover portion.

11. A motor comprising:
the resolver according to claim 9;
the rotating body including a shaft disposed coaxially with the center axis, and a rotor magnet rotating integrally with the shaft; and
a fixed body including a stator radially opposite to the rotor magnet; wherein
the resolver rotor is attached to the shaft; and
the resolver stator is attached to the fixed body.

12. A resolver for sensing a circumferential position of a rotating body with respect to a center axis, comprising:
a resolver rotor arranged to rotate about the center axis;
a resolver stator having a resolver stator core radially opposite to the resolver rotor with a predetermined gap interposed therebetween;
an insulator made of an electrically insulating material and covering an outer surface of the resolver stator core; and
a plurality of coils having a conductive wire wound around the resolver stator core; wherein
the resolver stator core has a plurality of teeth which extend toward the resolver rotor and are circumferentially spaced;
the insulator has tooth cover portions arranged to cover the teeth;
the conductive wire is wound around the tooth cover portion;
a wall portion arranged to prevent winding deformation of the conductive wire is disposed integrally with the tooth cover portion; and
an injection gate scar is disposed on a top surface of the wall.

13. A resolver according to claim 12, wherein
the resolver rotor is disposed radially inside the resolver stator;
the wall portion includes an inner wall radially inside the coil, the inner wall extending axially upward from the tooth cover portion; and
the injection gate scar is disposed on the top surface of the inner wall.

14. A motor comprising:
the resolver according to claim 12;
the rotating body including a shaft disposed coaxially with the center axis, and a rotor magnet rotating integrally with the shaft; and
a fixed body including a stator radially opposite to the rotor magnet; wherein
the resolver rotor is attached to the shaft; and
the resolver stator is attached to the fixed body.
